(19) United States
(12) Patent Application Publication
(10) Pub. No.: US 2006/0171556 A1
(43) Pub. Date: Aug. 3, 2006

(54) Cooling structure for loudspeaker driver

(75) Inventor: Brock M. Jabara, Wichita, KS (US)

Correspondence Address: JONES, TULLAR & COOPER, P.C., P.O. BOX 2266 EADS STATION, ARLINGTON, VA, 22202, US

(73) Assignee: Galaxy Audio, Inc.

(21) Appl. No.: 11/304,892

(22) Filed: Dec. 16, 2005

Related U.S. Application Data
(60) Provisional application No. 60/636,488, filed on Dec. 17, 2004.

(51) Int. Cl. H04R 1/00

(52) U.S. Cl. 381/397

(57) ABSTRACT

An efficient durable loudspeaker driver having a unique combination of thermally conductive, convective and radiating elements is provided to allow efficient cooling of its magnetic structure and voice coil. In accordance with a preferred embodiment of the present invention, the loudspeaker driver has a vented pole piece including first and second annular Neodymium magnets of opposing flux direction sandwiching a thermally conductive (e.g., steel) flux focusing annular pole piece in a multi-chamber ventilating structure. A first chamber is located above the pole piece and is driven by motion of the voice coil to pump air through the center of the pole piece. A second chamber surrounds the pole piece within the driver motor cup, and is vented through the lower portion of the pole piece, and a third chamber is located between the support basket and a spider and is vented through the thermally conductive basket which has a radial array of cooling fins connected to the cup.

This application claims priority to and benefit of U.S. Provisional Application No. 60/636,488, filed on Dec. 17, 2004, the entire disclosure of which is hereby incorporated herein by reference.

### FIELD OF THE INVENTION

The present invention relates to instruments for sound reproduction, and more particularly to loudspeaker drivers.

### BACKGROUND OF THE INVENTION

Moving coil loudspeaker designs for high quality sound reproduction are well known. An example of such a design is in sound reinforcement monitors for use on a stage to permit a vocalist to hear the signals being fed into the amplifiers without the confusing effects of the delayed reflections that are often experienced in large performance spaces. Such monitor speakers must be compact enough to permit use on a microphone boom stand or in other near-field locations, and typically include a mid-range speaker for intermediate (voice range) frequencies. Such prior art drivers typically utilize a circular basket supporting a frustoconical driver diaphragm, and customarily the small end of the diaphragm supports a cylindrical voice coil former upon which is wound a conductive voice coil having positive and negative terminal ends. Conventional drivers utilize a basket that closely follows the frustoconical shape of the driver diaphragm and supports the motor magnet and the circular diaphragm surround in an axial alignment, permitting an axial movement of the diaphragm in response to excitation of the voice coil.

A common concern with such loudspeakers is driver failure due to thermal overloading problems, for substantial amounts of power are required to provide adequate sound pressure levels so that a vocalist can hear the monitor over the level of the amplified sound; stage sound levels can be over 130 decibels (dB). High power sound outputs from the monitor require very large current flows through voice coil conductors, and these currents generate substantial heat in the voice coil.

Loudspeaker drivers include one or more magnetic structures incorporating one or more permanent magnets to provide a magnetic flux that is concentrated across a magnetic gap, where the flux acts on the voice coil. Neodymium is a new permanent magnet material which has been used in loudspeakers because it offers advantages when compared to the traditional ceramic magnets; however, neodymium suffers from a serious drawback, in that increasing temperature adversely affects its magnetic properties. Since current passing through a voice coil must, of necessity, generate heat through ohmic losses, high power applications have been ill-suited for speakers using neodymium magnets.

### SUMMARY OF THE INVENTION

In order to overcome the foregoing difficulties, a loudspeaker driver having a unique combination of thermally conductive, convective and radiating elements is provided to allow efficient cooling of its magnetic structure and voice coil. In accordance with a preferred embodiment of the present invention, the loudspeaker driver has first and second annular Neodymium magnets of opposing flux direction sandwiching a thermally conductive (e.g., steel) flux focusing annular pole piece in a multi-chamber ventilating structure. A frustoconical diaphragm or cone has at its forward end an outer peripheral edge that is substantially circular and is attached via a flexible surround to a thermally conductive support basket. At its back end the cone has an inner peripheral edge defining a substantially circular voice coil support opening, with the opening being covered by a substantially circular and impermeable dust cap. An annular voice coil support is secured to the cone, and carries a tubular voice coil former that is suspended in an annular magnetic gap for the loudspeaker driver motor. An outer cylindrical surface of the gap is defined by an annular interior surface of a driver motor steel cup. The cup supports a central stack of annular magnetic flux focusing elements, including first and second neodymium annular magnetic discs separated by an annular metal (e.g., steel) plate of selected thickness, which extends upwardly into the voice coil former. This annular stack has an outer surface that defines the interior cylindrical surface of the magnetic gap.

The tubular voice coil former carries an underhung voice coil that is positioned in the gap and is immersed in a thermally conductive fluid such as ferro-fluid to seal the gap and to facilitate motion of the voice coil with respect to the outer cup and the inner stack.

The fluid is located in the portions of the magnetic gap inside and outside of the voice coil former. The fluid also serves to conduct heat from the voice coil through the inner portion of the gap to the steel plate in the central stack of flux-focusing elements, and through the outer portion of the gap to the driver motor steel cup. The heat transferred to the stack by the fluid is then removed by air flow from a first cooling chamber vent through the center of the central stack, while the heat transferred to the cup is removed by air flow from two additional cooling chambers, and by conductive heat transfer from the driver motor steel cup to multiple radial ribs forming part of the support basket that surrounds the diaphragm.

The first cooling chamber is formed between the cone's dust cap and the driver motor's central stack. The portion of the thermally conductive voice coil cooling fluid that is suspended in the inner portion of the magnetic gap prevents air from passing between the voice coil former and the central stack to effectively seal this first chamber. The chamber is vented through a vertical passageway extending axially through the center of the stack and through the bottom of the motor structure to the surrounding air. Motion of the loudspeaker diaphragm caused by energizing the driver voice coils causes this first chamber to expand and contract, driving air into and out of the first cooling chamber and through the passageway. This air provides a cooling flow through the central stack to remove heat.

A second air chamber is located within the driver motor steel cup. This chamber is closed off at its upper end by the cooling fluid in the inner and outer portions of the magnetic gap, and is vented by a horizontal passageway leading to the vertical vent passageway. Air in this second chamber is in contact with both the central stack and the steel cup, and this air is circulated into and out of the chamber by the motion of the voice coil and by the flow of air through the vertical passageway.

A third air chamber is formed between the support basket and an annular spider that extends between the dust cap and the support basket. The spider protects the back of the diaphragm, and moves with the voice coil to pump air through a multiplicity of vent holes in the basket. The flow of air into and out of this third chamber provides a cooling flow of air through the basket and past the multiple ribs forming the basket.

The basket ribs are fabricated from a thermally conductive material such as aluminum, and are in thermal contact with the metal cup to serve as heat-radiating fins to transfer heat away from the driver motor. The system of cooling chamber vents described above is arrayed in the central stack pole piece and through the thermally conductive basket to permit convective cooling for each of the first, second and third chambers without pumping the thermally conductive fluid out of the voice coil's magnetic gap. This venting aperture configuration together with the thermally conductive fins provides significant voice coil cooling and enhanced long-term, high power reliability.

### BRIEF DESCRIPTION OF THE DRAWINGS

The foregoing, and additional objects, features and advantages of the present invention will become apparent to those of skill in the art from the following detailed description of a preferred embodiment thereof, taken with the accompanying drawings, in which:

FIG. 1 is a perspective view of a loudspeaker incorporating the cooling features of the present invention;

FIG. 2 is a back elevation view of the loudspeaker of FIG. 1;

FIG. 3 is a side elevation view of the loudspeaker of FIG. 1;

FIG. 4 is a diagrammatic cross-sectional view taken along line 4-4 of FIG. 2; and

FIG. 5 is an enlarged view of a portion of the device of FIG. 4.

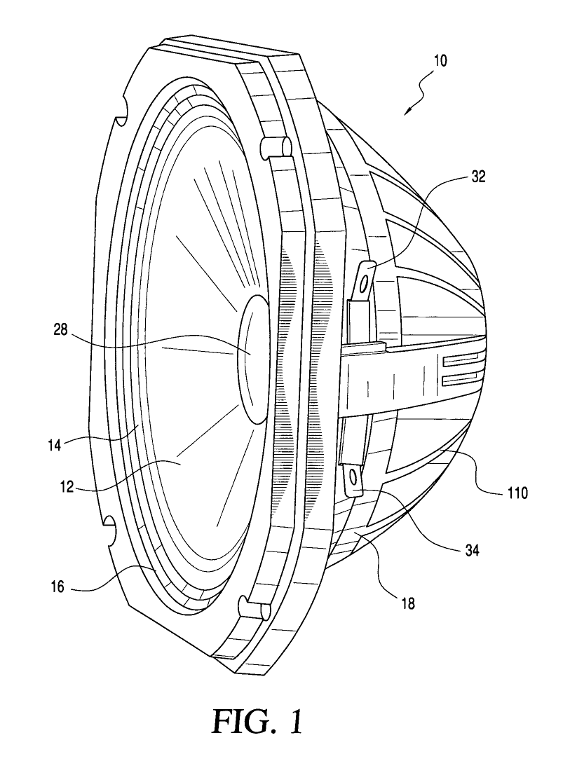

### DESCRIPTION OF PREFERRED EMBODIMENT

Turning now to a more detailed description of one embodiment of the present invention, the Figures illustrate an audio loudspeaker 10 having a frusto-conical diaphragm, or cone, 12 incorporating an outer peripheral forward edge 14 that typically is substantially circular. The cone is attached at its distal or forward peripheral edge to a flexible surround 16 that, in turn, is secured to a distal flange carried by thermally conductive support basket 18. At its back or proximal end, the cone 12 has an inner peripheral edge 20 which defines a substantially circular voice coil support opening 22 secured to a second band of Kapton™ providing voice coil support 24, which receives and secures a tubular or cylindrical voice coil former 26. The opening 22 and the top of the former 26 are preferably covered by a substantially gas impermeable dust cap 28.

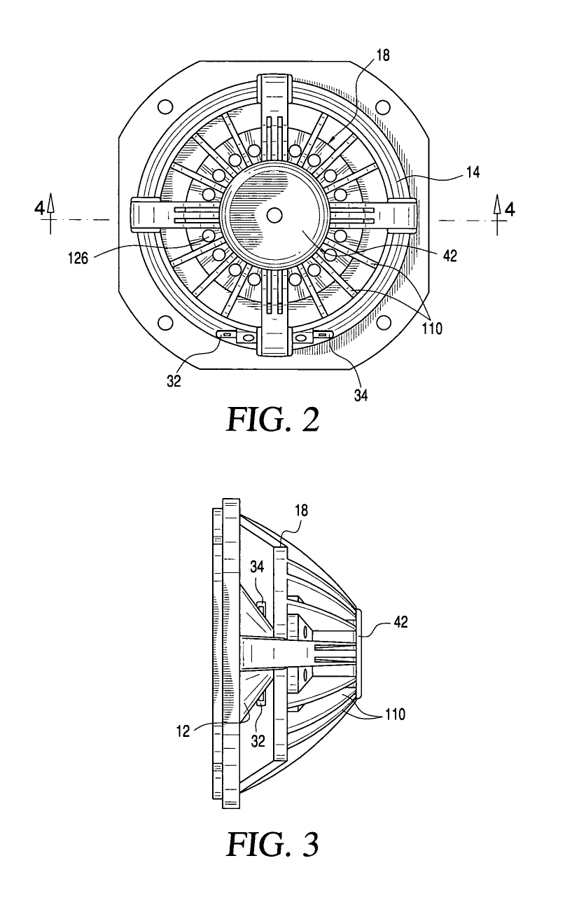

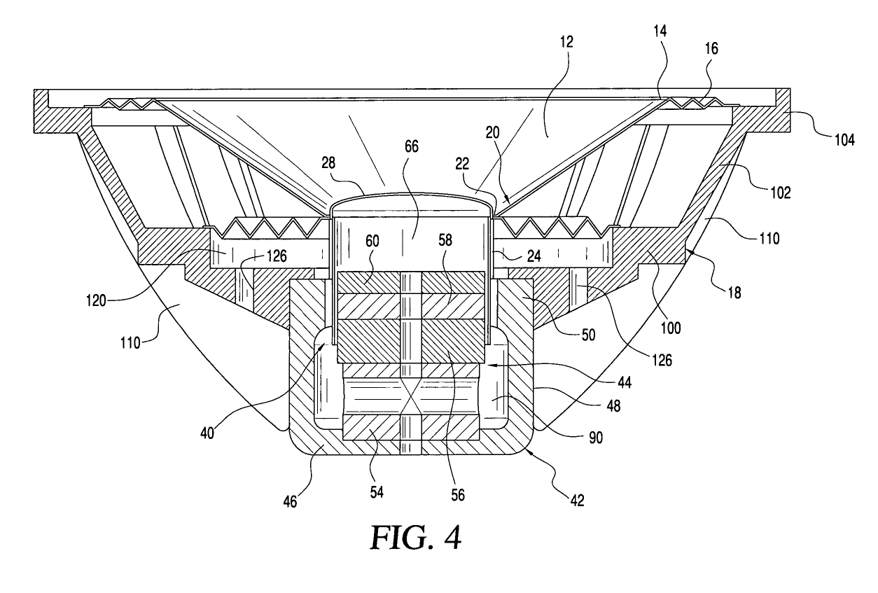

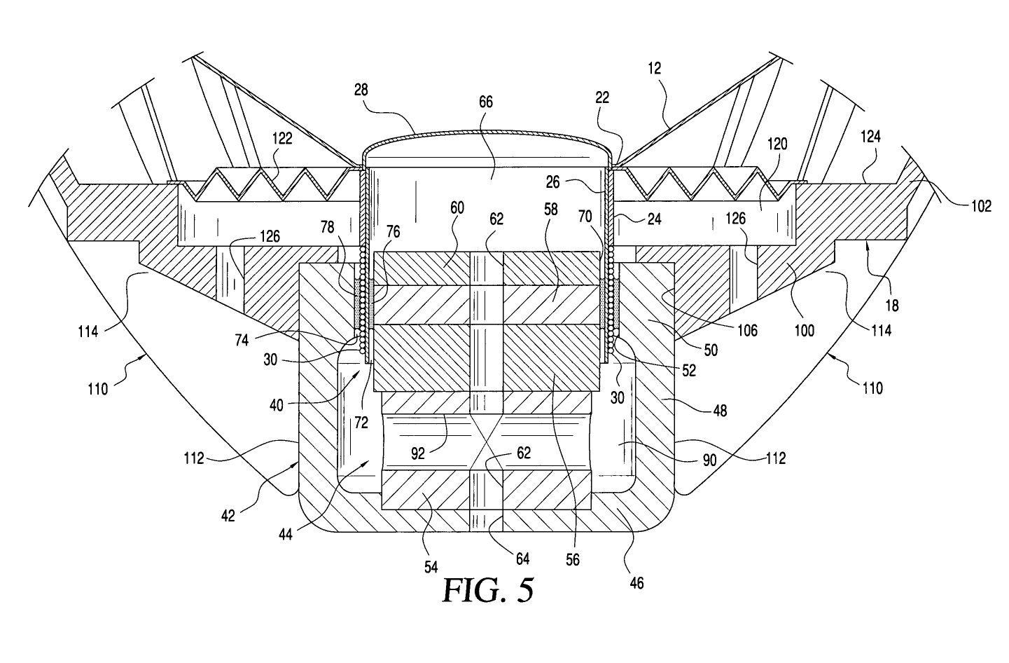

A suitable conductive voice coil winding 30 (FIG. 5) is wound around the former 26 in known manner and has two leads connected to terminals 32 and 34 (FIG. 2) for connecting the loudspeaker to a suitable source of audio drive signals (not shown). The former 26 and its voice coil 30 are suspended in an annular magnetic gap 40 that is formed between a substantially cylindrical inner wall surface 52 of driver motor steel cup 42 and a central stack, or pole piece assembly, 44 supported in a base portion 46 of the steel cup 42.

As illustrated, cup 42 includes an annular wall 48 extending upwardly from the periphery of base portion 46, with the upper edge of the wall incorporating an annular rim portion 50 having an inner surface 52 that defines the outer circumference of the magnetic gap 40. Stack 44 includes a vented support 54 secured to the base 46. On top of support 54 is a first annular permanent magnet 56 that, in turn, supports an annular metal plate 58. The plate 58, in turn, supports a second permanent magnet 60. The annular elements 54, 56, 58 and 60 of stack 44 form a pole piece for the loudspeaker driver, and have their central apertures coaxially aligned to form a central vent 62 that extends vertically completely through the stack. An aperture 64 in base 46 is aligned with vent 62, to open the vent to the external ambient atmosphere. The upper end of vent 62 is open to a central air chamber 66 located inside the former 26, below dust cap 28 and above the stack 44. The outer surfaces of the elements 56, 58 and 60 of the stack 44 are circular and aligned to form an inner wall surface 70 of the magnetic gap 40.

The spacing between the outer surface 52 and the inner surface 70 of the magnetic gap is sufficiently wide to receive the voice coil 30 and former 26 for linear oscillating motion with respect to the stationary magnets 56 and 60, but is sufficiently small to ensure maximum force on the voice coil to drive the diaphragm 12, in known manner. The voice coil and former cooperate with the stack 44 to form an inner gap portion 72, and cooperate with the wall 52 of rim portion 50 to form an outer gap portion 74. To improve the operation of the loudspeaker, by reducing distortion and power compression while increasing speaker life, a thermally conductive fluid such as ferro-fluid™ is placed in the inner and outer gaps, as indicated at 76 and 78. As described above, the ferro-fluid seals the gaps and facilitates the transfer of heat away from the voice coil to the surrounding thermally conductive motor structure.

The permanent magnets 56 and 60 are Neodymium, in the preferred form of the invention, although it will be understood that the cooling structure described herein can be used with other magnetic materials, if desired. Neodymium is preferred, however, for it provides an extremely intense magnetic field in comparison to its weight. The two magnets are positioned in opposition in stack 44 to produce a concentrated flux field in the magnetic gap 40 at the annular flux-focusing plate 58, while the winding 30 preferably is an edge wound voice coil to increase the efficiency of the loudspeaker and to produce a better high frequency response.

A second or proximal cooling chamber 90 is formed around the lower portion of the stack 44, inside the gas impermeable drive motor cup 42. The top or distal end of proximal chamber 90 is sealed by the ferro fluid material 76 and 78 that is in the gap 40, but this chamber 90 is vented to the vertical vent passageway 62 by way an intersecting horizontal vent passageway 92 which provides fluid communication thereto.

The support basket 18 includes a generally dish-shaped bottom portion 100 and an upwardly sloping side leg portion 102 that generally parallels the cone 12. A peripheral rim portion 104 of the basket secures the distal flexible surround 16 to support the cone. The bottom portion 100 of the basket has a central opening 106 that receives and secures the rim portion 50 of the drive motor cup 42 to provide a rigid support structure for the movable diaphragm and its suspended voice coil. The basket is formed of a thermally conductive material, and securely engages the rim portion of the cup 42 to provide a good thermal contact to facilitate heat flow away from the cup. Additional cooling of the drive motor cup 42 is provided by multiple radially-extending fins, or ribs, 110 spaced around the circumference of the loudspeaker. The inner edges 112 of the fins are in thermal contact with the wall 48 of the cup 42, while the upper edges 114 are in thermal contact with the dish-shaped basket 18. The fins are of a thermally conductive material such as aluminum, and extend radially outwardly to transfer heat away from the basket by conduction and convection with the surrounding ambient atmosphere.

A third or distal cooling chamber 120 is formed above the bottom portion 100 of the basket 18 by means of a conventional and at least partially gas impermeable flexible spider 122 that extends outwardly from the top of the former cylinder 26 to a shoulder 124 on the basket 18. The spider moves with the voice coil to expand and contract the enclosed chamber 120. This chamber is vented proximally through a plurality of vent passageways 126 that are spaced around the bottom portion 100 of the basket 18.

In operation, energization of the driver voice coil 30 to drive the diaphragm 12 creates heat in the driver's voice coil 30. This heat is transferred to the pole piece, or stack, 44 and to the cup 42 by convection and radiation, and by conduction through the ferro fluid 76 and 78 in the magnetic gap 40. Heat transferred to the stack is removed by air flow through vent 62, which passes through the center of the stack. This air flow is produced by the motion of the voice coil and the former 26, which expands and contracts the air chamber 66 and pumps air into and out of the chamber. The motion of the voice coil also acts upon chamber 90 to cause air flow through intersecting horizontal vent passageway 92, and expands and contracts chamber 120 to cause air flow through vent passageways 126. The air flow into and out of chambers 66 and 90 removes heat from the stack 44 and from the cup 42. The basket 18 and the fins 110 also remove heat from the cup 42, and the flow of air into and out of chamber 120 by way of vents 126 serves to cool the basket and helps to cool the fins 110. All of these components cooperate to provide cooling of the voice coil through convection, radiation, and conduction to prevent overheating of the magnetic material in stack 44 and to thereby provide improved performance and extended life for the loudspeaker.

Although the invention has been described in terms of a specific embodiment, it will be understood that numerous variations and modifications can be made without departing from the true spirit and scope of the invention, as set forth in the following claims.

What is claimed is:

1. A vented loudspeaker driver, comprising:
a motor structure including first and second annular neodymium magnets sandwiching a thermally conductive annular flux focusing pole piece;
said motor structure being carried by a frustoconical thermally conductive frame with a substantially circular, planar spider supporting plateau surrounding an annular volume;
said frame further comprising a distal, substantially circular, planar, surround supporting flange;
a frustoconical diaphragm carrying a flexible surround on a distal peripheral outer edge of said diaphragm, said diaphragm terminating proximally in an inner peripheral edge sealed with a dust cap and carrying a cylindrical voice coil former that supports a thermally conductive voice coil;
said diaphragm carrying a flexible annular spider suspension member having an outer peripheral edge;
wherein said diaphragm spider is substantially sealed to said frame spider supporting plateau to define, in said annular volume, a distal pumped chamber volume ventilating said motor structure proximally when said diaphragm moves relative to said motor structure.

2. The vented loudspeaker driver of claim 1, wherein said motor structure defines a proximal pumped chamber when said diaphragm voice coil former is positioned over said pole piece and the magnetic gap therebetween is substantially sealed or occluded with a magnetic, thermally conductive fluid;
wherein said diaphragm dust cap encloses a central pumped chamber and forces air through said pole piece when said diaphragm moves closer to said pole piece during a diaphragm excursion.

3. The vented loudspeaker driver of claim 2, wherein said motor structure's central and proximal pumped chambers are in fluid communication with one another and are vented to atmosphere by vents defined in said pole piece;
wherein said diaphragm dust cap forces air through a central passage in said thermally conductive annular flux focusing pole piece when said diaphragm moves during a diaphragm excursion.

4. The vented loudspeaker driver of claim 2, wherein said motor structure includes a pole assembly comprising a first, flux down oriented, annular neodymium magnet, and a second, flux up oriented, annular neodymium magnet;
and wherein said first and second magnets both direct flux into said thermally conductive annular flux focusing pole piece positioned to define an annular magnetic gap while cooling said first and second magnets by convection and conduction.

5. A linear motor structure adapted for use in, for example, a loudspeaker driver, comprising:
first and second neodymium magnets sandwiching a thermally conductive flux focusing pole piece;
a thermally conductive frame configured to carry the motor structure and comprising a distal, surround supporting flange and a proximal spider supporting flange;
a diaphragm carrying a flexible surround on a distal peripheral outer edge of said diaphragm, said diaphragm terminating proximally in an inner peripheral edge sealed with a dust cap and carrying a hollow voice coil former that supports a thermally conductive voice coil;
said diaphragm carrying a flexible spider suspension member having an outer peripheral edge;
wherein said diaphragm spider is substantially sealed to said frame spider supporting plateau to define a distal pumped chamber volume ventilating said motor structure proximally when said diaphragm moves relative to said motor structure.

6. The linear motor structure of claim 5, wherein said motor structure defines a proximal pumped chamber when said diaphragm voice coil inserted over said pole piece and the magnetic gap therebetween is substantially sealed or occluded with a magnetic, thermally conductive fluid;

7. The linear motor structure of claim 6, wherein said diaphragm dust cap encloses a central pumped chamber and forces air through said pole piece when said diaphragm moves closer to said pole piece during a diaphragm excursion.

8. The linear motor structure of claim 7, wherein said motor structure's central and proximal pumped chambers are in fluid communication with one another and are vented to atmosphere by vents defined in said pole piece;
wherein said diaphragm dust cap forces air through a central passage in said thermally conductive annular flux focusing pole piece when said diaphragm moves closer to said pole piece during a diaphragm excursion.

9. The linear motor structure of claim 8, wherein said motor structure includes a pole assembly comprising a first, flux down oriented, annular neodymium magnet, and a second, flux up oriented, annular neodymium magnet; and wherein said first and second magnets both direct flux into said thermally conductive flux focusing pole piece which is configured to define an annular magnetic gap.

10. The linear motor structure of claim 9, wherein said motor structure cools said first and second magnets by convection and conduction.

11. The linear motor structure of claim 10, wherein said motor structure includes a thermally conductive gas impermeable cup-shaped member having a distal opening providing fluid communication between the atmosphere and said central and proximal chambers.
